(19) United States
(12) Patent Application Publication
(10) Pub. No.: US 2026/0336366 A1
(43) Pub. Date: Oct. 29, 2026

(54) UNIT COOLER

(71) Applicant: KABUSHIKI KAISHA TOYOTA JIDOSHOKKI, Kariya-shi (JP)

(72) Inventors: Hiromichi OGAWA, Kariya-shi (JP); Hisaya KONDO, Kariya-shi (JP); Kengo SAKAKIBARA, Kariya-shi (JP); Satoru SHIMADA, Kariya-shi (JP); Ryota WATANABE, Kariya-shi (JP)

(73) Assignee: KABUSHIKI KAISHA TOYOTA JIDOSHOKKI, Kariya-shi (JP)

(21) Appl. No.: 19/569,116

(22) Filed: Mar. 17, 2026

(30) Foreign Application Priority Data
Mar. 28, 2025 (JP) 2025-057062

(51) Int. Cl. B60H 1/32; B60H 1/00

(52) U.S. Cl. CPC B60H 1/3229; B60H 1/00357; B60H 1/00428; B60H 1/3222; B60H 2001/3286

(57) ABSTRACT

A unit cooler includes a housing having an intake port and a discharge port, an air conditioning unit, and a base frame on which the air conditioning unit is mounted. The air conditioning unit includes an electric compressor, a condenser, a pressure reducing device, an evaporator, a first fan configured to rotate to blow the air to flow through the condenser, a second fan configured to rotate to blow the air to flow through the evaporator, an inverter configured to drive the electric compressor, and a power conversion device configured to convert electric power to be input to the inverter. The base frame includes a bracket to which the electric compressor is fixed, the bracket being formed by bending such that the air drawn in through the intake port with rotation of the first fan flows to the power conversion device.

### CROSS-REFERENCE TO RELATED APPLICATION

This application claims priority to Japanese Patent Application No. 2025-057062 filed on March 28, 2025, the entire disclosure of which is incorporated herein by reference.

The present disclosure relates to a unit cooler.

### BACKGROUND ART

Japanese Patent Application Publication No. 2024-140629 discloses a conventional unit cooler. The unit cooler is used in industrial vehicles such as a forklift truck having a power source.

The unit cooler includes a housing and an air conditioning unit. The housing has an intake port through which air is drawn in and a discharge port through which the air drawn in through the intake port is discharged. The air conditioning unit is accommodated in the housing, forms a part of a refrigeration cycle, cools air drawn in through the intake port and discharges the cooled air through the discharge port. The air conditioning unit includes an electric compressor, a condenser, a pressure reducing device, and an evaporator. The air conditioning unit also includes a first fan that rotates to cause air to flow through the condenser, and a second fan that rotates to cause air to flow through the evaporator. The electric compressor is disposed between the condenser and the evaporator, the first fan is disposed between the electric compressor and the condenser, and the second fan is disposed between the electric compressor and the evaporator.

The first fan blows air drawn in through the intake port to the condenser, thereby releasing heat of the condenser. The second fan blows air drawn in through the intake port to the evaporator, cools the air by heat absorption by the evaporator, and discharges the cooled air through the discharge port. At this time, a duct, which is provided at the discharge port, allows the air having passed the second fan to be discharged toward a driver outside the housing.

The housing also includes an outer upper cover and an outer under cover. A base plate that has a plate shape and to which an air conditioning unit is mounted, and a top plate are disposed between the outer upper cover and the outer under cover. The air conditioning unit, the base plate, and the top plate form an air conditioning module including a piping.

The industrial vehicles equipped with the unit cooler have various power supply voltages and various required cooling capacities. For this reason, when the electric compressor is driven by an inverter, the air conditioning unit preferably has a power conversion device, such as a DC-DC converter, which converts voltage input to the inverter.

However, since the power conversion device contains a plurality of switching elements and other heat-generating components, if the power conversion device is mounted on the base plate as it is as an air conditioning unit, it is difficult to release heat from the power conversion device, which deteriorates cooling performance.

The present disclosure has been made in view of the above-mentioned conventional circumstances, and is directed to providing a unit cooler that has excellent cooling performance even when an air conditioning unit includes a power conversion device.

### SUMMARY

In accordance with an aspect of the present disclosure, there is provided a unit cooler including a housing having an intake port through which air is drawn in, and a discharge port through which the air drawn in through the intake port is discharged; an air conditioning unit accommodated in the housing, forming a refrigeration cycle, and configured to cool the air drawn in through the intake port and discharge the cooled air through the discharge port; a base frame made of a metal plate disposed in the housing, and on which the air conditioning unit is mounted. The air conditioning unit includes an electric compressor, a condenser, a pressure reducing device, an evaporator, a first fan configured to rotate to blow the air to flow through the condenser, a second fan configured to rotate to blow the air to flow through the evaporator, an inverter configured to drive the electric compressor, and a power conversion device configured to convert electric power to be input to the inverter. The base frame includes a bracket to which the electric compressor is fixed, the bracket being formed by bending such that the air drawn in through the intake port with rotation of the first fan flows to the power conversion device.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view of a forklift truck on which a unit cooler according to a first embodiment is mounted;

FIG. 2 is an exploded perspective view of a housing and surrounding parts in the unit cooler according to the first embodiment;

FIG. 3 is an exploded perspective view of an air conditioning module and surrounding parts in the unit cooler according to the first embodiment;

FIG. 4 is a perspective view of the unit cooler according to the first embodiment;

FIG. 5 is an exploded perspective view illustrating a base plate of a base frame, a bracket, and a DC-DC converter as a power conversion device in the unit cooler according to the first embodiment;

FIG. 6 is a schematic horizontal cross-sectional view of the unit cooler according to the first embodiment;

FIG. 7 is a schematic vertical cross-sectional view of the unit cooler according to the first embodiment; and

FIG. 8 is a cross-sectional view of a main part of a unit cooler according to a second embodiment.

### DETAILED DESCRIPTION OF THE EMBODIMENTS

The following will describe first and second embodiments of the present disclosure with reference to the accompanying drawings.

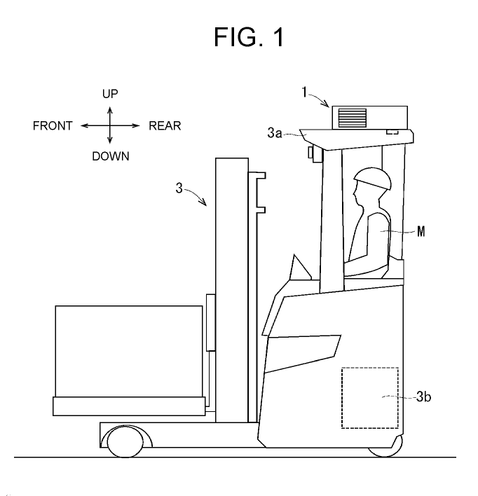

As illustrated in FIG. 1, a unit cooler 1 according to the first embodiment is fixed to a headguard 3a of an electric forklift truck (hereinafter simply referred to as a forklift truck 3). The forklift truck 3 is of a reach type, and is an example of an industrial vehicle. In the following, a front-rear direction, an up-down direction, and a left-right direction of the forklift truck 3 illustrated in FIG. 1 are used for describing directions of the unit cooler 1. The forklift truck 3 includes a battery 3b as a power source, and is operated by an operator M to travel and perform cargo handling operation using electric power supplied from the battery 3b.

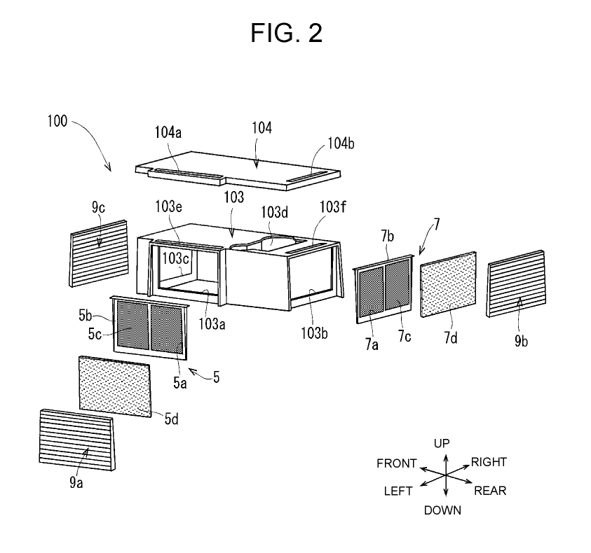

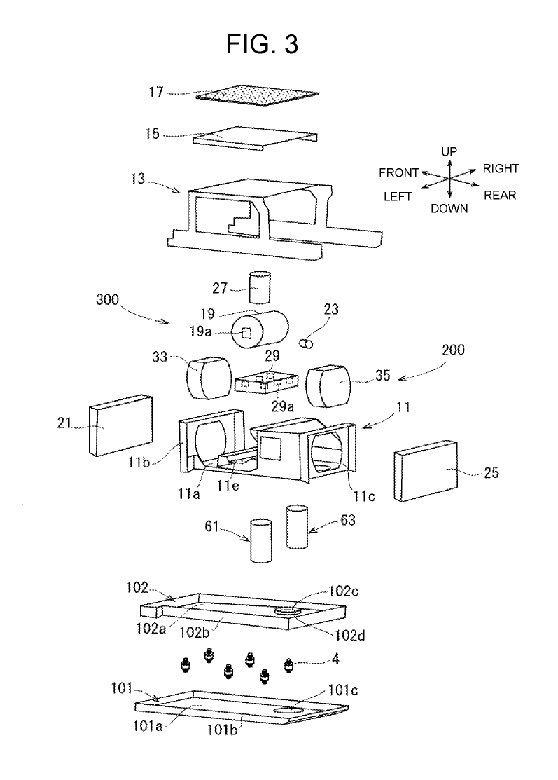

As illustrated in FIGS. 2 and 3, the unit cooler 1 includes a housing 100 and an air conditioning module 300. It is noted that a sealing member and a rubber foam are not illustrated in FIGS. 2 and 3.

The housing 100 includes an outer undertray 101 and an inner undertray 102, which are illustrated in FIG. 3, and an outer upper cover 103 and an outer top cover 104, which are illustrated in FIG. 2. The outer undertray 101 is made of a sheet metal, and the inner undertray 102, the outer upper cover 103, and the outer top cover 104 are made of resin.

As illustrated in FIG. 3, the outer undertray 101 includes a bottom plate 101a having a rectangular plate shape that is long in the front-rear direction, and a peripheral wall 101b protruding upward from a periphery of the bottom plate 101a. Two outlet ports 101c (only one of which is illustrated in FIG. 3) are disposed side by side in the left-right direction and formed through a rear portion of the bottom plate 101a. The bottom plate 101a and the peripheral wall 101b have a plurality of through holes (not illustrated) for mounting the unit cooler 1.

The air conditioning module 300 includes a base frame 11, an upper frame 13, a top frame 15, and an air conditioning unit 200 fixed to these parts and accommodated in the housing 100. The base frame 11, the upper frame 13, and the top frame 15 are made of a sheet metal. A sponge rubber sheet 17 is disposed between the top frame 15 and the outer upper cover 103.

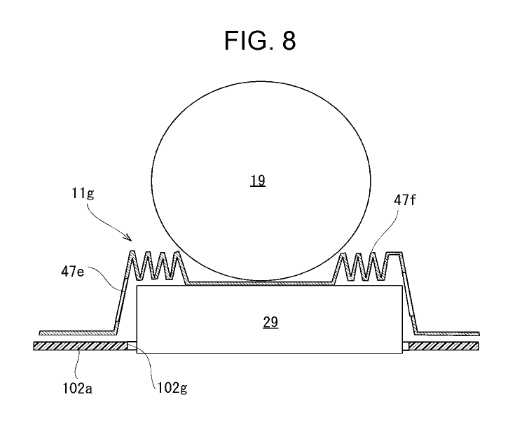

Six vibration-damping members 4, each extending through the inner undertray 102 and having a vibration damping rubber, are provided between the outer undertray 101 and the base frame 11. The inner undertray 102 has a bottom plate 102a having a rectangular plate shape, which is slightly smaller than the bottom plate 101a of the outer undertray 101, and a peripheral wall 102b protruding upward from a periphery of the bottom plate 102a. Outlet ports 102c (only one of which is illustrated in FIG. 3) are formed through a rear portion of the bottom plate 102a so as to be aligned with the outlet ports 101c of the outer undertray 101, respectively. A standing wall 102d protrudes upward from an inner edge of each of the outlet ports 102c. As illustrated in FIG. 8, a through hole 102g is formed through a front portion of the bottom plate 102a, and a partition wall 102h that protrudes upward is formed from an inner edge of the through hole 102g. The inner undertray 102 is configured to receive condensate generated in an evaporator 25.

As illustrated in FIG. 2, the outer upper cover 103 has a box shape, which is a rectangular parallelepiped box extending long in the front-rear direction and has an opening in a lower end. The outer upper cover 103 has a first intake port 103a formed through a front portion of a left wall, a second intake port 103b formed through a rear wall, and a discharge port 103c formed through a front wall. The first intake port 103a, the second intake port 103b, and the discharge port 103c are located at the same height in the vertical direction.

The outer upper cover 103 has a duct recess 103d that is recessed downward from an upper wall extending horizontally. Furthermore, a first opening 103e and a second opening 103f are formed through the upper wall of the outer upper cover 103.

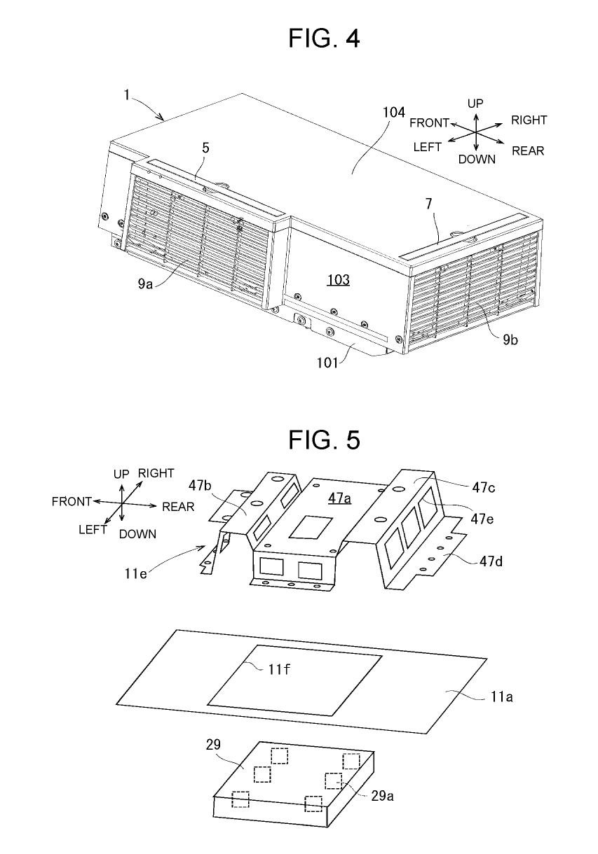

The outer top cover 104 has a plate shape that matches an upper surface of the outer upper cover 103. A sealing member (not illustrated) is disposed between the outer top cover 104 and the duct recess 103d of the outer upper cover 103. As illustrated in FIG. 4, the outer top cover 104 is joined to the outer upper cover 103 to form a main exterior of the unit cooler 1. As illustrated in FIG. 2, the outer top cover 104 has a first opening 104a that aligns with the first opening 103e of the outer upper cover 103, and a second opening 104b that aligns with the second opening 103f of the outer upper cover 103.

A first filter 5 is insertable into and removable from the first openings 104a and 103e from above. A second filter 7 is insertable into and removable from the second openings 104b and 103f from above. The first filter 5 is formed of a frame 5b in which two windows 5a are formed, meshes 5c made of metal and attached to the windows 5a, and a sponge 5d provided on an outer surface of the frame 5b. The second filter 7 is formed of a frame 7b in which two windows 7a are formed, meshes 7c made of metal and attached to the windows 7a, and a sponge 7d provided on an outer surface of the frame 7b.

The sponge 5d and the meshes 5c cover an outer side of the first intake port 103a of the outer upper cover 103 with the first filter 5 inserted into the first opening 104a and the first opening 103e. The sponge 7d and the meshes 7c cover an outer side of the second intake port 103b of the outer upper cover 103 with the second filter 7 inserted into the second opening 104b and the second opening 103f. In addition, a louver 9a is provided at the first intake port 103a so as to be positioned on an outer side of the sponge 5d, and a louver 9b is provided at the second intake port 103b so as to be positioned on an outer side of the sponge 7d. A louver 9c is provided at the discharge port 103c.

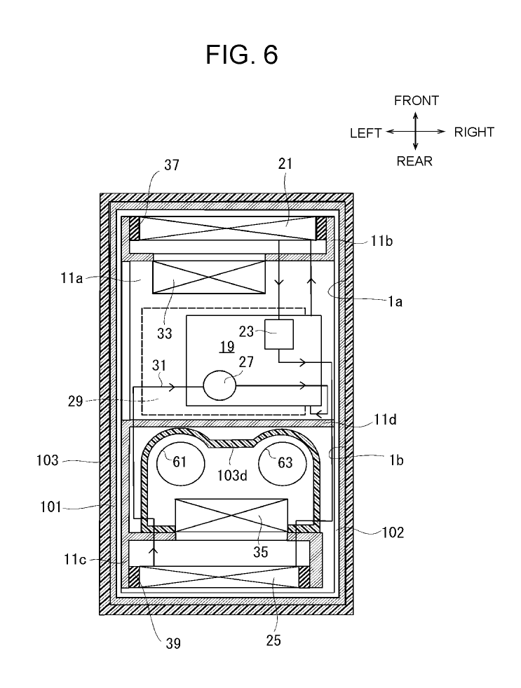

As illustrated in FIG. 3, the base frame 11 is formed by bending and joining a plurality of metal plates. The base frame 11 has a base plate 11a, which has a rectangular plate shape that is long in the front-rear direction and extends horizontally, a first guide frame 11b fixed to a front end of the base plate 11a, and a second guide frame 11c fixed to a rear end of the base plate 11a. As illustrated in FIG. 6, the base frame 11 also has a partition wall 11d fixed to the center of the base plate 11a. The partition wall 11d divides the base frame 11 into a front portion and a rear portion. The partition wall 11d has a plurality of through holes (not illustrated) for mounting.

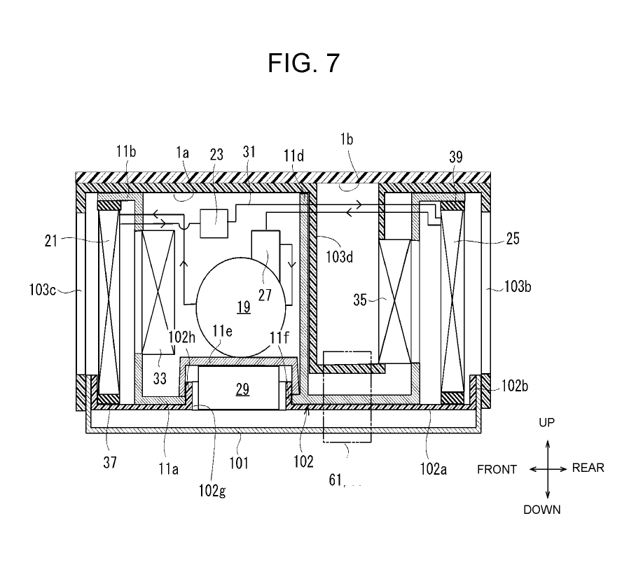

Furthermore, as illustrated in FIG. 5, a through hole 11f is formed through the front portion of the base plate 11a. The partition wall 102h of the inner undertray 102 is inserted into the through hole 11f, as illustrated in FIG. 7. A bracket 11e having a trapezoid shape is fixed around the through hole 11f. In FIG. 7, the vibration-damping members 4 are not illustrated.

As illustrated in FIG. 5, the bracket 11e has a seating surface 47a extending horizontally in the left-right direction, fins 47b, 47c that are formed by bending in a stepped shape and disposed on the opposite side of the seating surface 47a in the front-rear direction, and a plurality of mounting portions 47d. The seating surface 47a and the fins 47b, 47c each have a plurality of through holes for fixing mounting legs (not illustrated) or other components of an electric compressor 19. A plurality of through holes for fixing the bracket 11e to the base plate 11a is formed in the mounting portions 47d. The fins 47b, 47c extend away from the first intake port 103a, as illustrated in FIGS. 2 and 3. A plurality of through holes 47e is formed in the seating surface 47a, the fins 47b, 47c, and the mounting portions 47d of the bracket 11e.

As illustrated in FIG. 3, the air conditioning unit 200 includes the electric compressor 19, a condenser 21, an expansion valve 23, the evaporator 25, an accumulator 27, and a control device 29. An inverter 19a is incorporated in the electric compressor 19 on the first intake port 103a side. That is, the inverter 19a is provided integrally with the electric compressor 19. The inverter 19a may be provided separately from the electric compressor 19. The expansion valve 23 corresponds to a pressure reducing device. The control device 29 incorporates a DC-DC converter that converts voltage to be input to the inverter 19a. As illustrated in FIG. 5, the DC-DC converter has a plurality of switching elements 29a, and a magnetic member (not illustrated). The DC-DC converter corresponds to a heavy power conversion device. As illustrated in FIG. 7, the electric compressor 19, the condenser 21, the expansion valve 23, the evaporator 25, and the accumulator 27 are connected in this order with a piping 31, and form a refrigeration cycle that circulates refrigerant. The condenser 21 and the evaporator 25 are rectangular parallelepiped bodies of the same shape.

The electric compressor 19, the condenser 21, the expansion valve 23, the evaporator 25, and the accumulator 27 are fixed to an upper surface of the base plate 11a, and the electric compressor 19 is positioned between the condenser 21 and the evaporator 25. The electric compressor 19 is fixed to an upper surface of the bracket 11e, and the control device 29 is fixed to a lower surface of the bracket 11e. The condenser 21 is fixed to the first guide frame 11b, and the evaporator 25 is fixed to the second guide frame 11c.

As illustrated in FIG. 3, the air conditioning unit 200 includes a first fan 33 and a second fan 35. The first fan 33 and the second fan 35 each have a built-in motor. As illustrated in FIG. 7, the first fan 33 is disposed between the electric compressor 19 and the condenser 21, and is fixed to the first guide frame 11b. The second fan 35 is disposed between the electric compressor 19 and the evaporator 25, and is fixed to the second guide frame 11c.

The first guide frame 11b is provided between the condenser 21 and the first fan 33 so that air blown by the first fan 33 is guided to reach the entire condenser 21. Sealing members 37 to enhance airtightness are provided between the condenser 21 and the first guide frame 11b and between the first fan 33 and the first guide frame 11b.

The second guide frame 11c is also provided between the evaporator 25 and the second fan 35 so that air blown by the second fan 35 is guided to reach the entire evaporator 25. Sealing members 39 to enhance airtightness are also provided between the evaporator 25 and the second guide frame 11c and between the second fan 35 and the second guide frame 11c.

The control device 29 has a power cord (not illustrated) and a connection cord (not illustrated), the power cord is connected to the battery 3b of the forklift truck 3, and the connection cord is connected to the electric compressor 19, the first fan 33, and the second fan 35. The air conditioning module 300 is formed by fixing the upper frame 13 and the top frame 15 to the base frame 11 on which the air conditioning unit 200 is mounted.

As illustrated in FIGS. 2, 3 and 7 , ducts 61, 63 are disposed between the electric compressor 19 and the second fan 35 in the duct recess 103d of the outer upper cover 103 to discharge air having passed through the second fan 35 to an outside of the housing 100. The partition wall 11d of the base frame 11 is positioned between the electric compressor 19 and the ducts 61, 63. The partition wall 11d separates a first fan chamber 1a that is positioned in the front portion of the base frame 11 and into which air is drawn with rotation of the first fan 33 from a second fan chamber 1b that is positioned in the rear portion of the base frame 11 and into which air is drawn with rotation of the second fan 35. The first intake port 103a is in communication with the first fan chamber 1a, and the second intake port 103b is in communication with the second fan chamber 1b.

In the unit cooler 1, when the operator M turns a switch of the control device 29 on, the electric compressor 19 compresses the refrigerant, and the refrigerant is circulated through the condenser 21, the expansion valve 23, the evaporator 25, and the accumulator 27, to the electric compressor 19. Thus, air drawn in through the second intake port 103b is cooled while flowing through the evaporator 25, and the cool air is supplied to the operator M through the ducts 61, 63. In addition, the condenser 21 condenses the refrigerant using the air drawn in through the first intake port 103a, and releases heat to the discharge port 103c.

In the unit cooler 1, the base frame 11 made of a metal plate is disposed in the housing 100, and the air conditioning unit 200 is mounted to the base frame 11. In this case, the electric compressor 19 is disposed between the condenser 21 and the evaporator 25, the first fan 33 is disposed between the electric compressor 19 and the condenser 21, the second fan 35 is disposed between the electric compressor 19 and the evaporator 25, and the expansion valve 23 is disposed between the electric compressor 19 and the condenser 21. On the other hand, the control device 29 including the DC-DC converter is mounted to the base frame 11 on a side thereof opposite from the electric compressor 19.

More specifically, the base frame 11 has the base plate 11a to which the bracket 11e is fixed, the electric compressor 19 is attached to the upper surface of the bracket 11e, and the control device 29 is attached to the lower surface of the bracket 11e. This allows the electric compressor 19 and the control device 29 to be fixed to the base frame 11 easily.

Here, the housing 100 has the first intake port 103a, and air is drawn in through the first intake port 103a by the first fan 33. The base frame 11 has the bracket 11e formed by bending, and air drawn in through the first intake port 103a with operation of the first fan 33 flows toward the control device 29 by the bracket 11e. Accordingly, in the unit cooler 1, the control device 29 is easily cooled and cooling performance can be maintained.

In the unit cooler 1, the bracket 11e has the seating surface 47a and the fins 47b, 47c, and the fins 47b, 47c extend away from the first intake port 103a. As a result, the fins 47b, 47c increase the surface area of the bracket 11e and allow air taken in through the first intake port 103a to flow along an upper surface and a lower surface of the bracket 11e, thereby improving heat release performance.

Furthermore, in the unit cooler 1, since the bracket 11e has the plurality of through holes 47e, air flowing toward the control device 29 flows toward the first fan 33, which increases the airflow to the control device 29 and hence heat release performance.

In the unit cooler 1, the DC-DC converter of the control device 29 has the plurality of switching elements 29a, and the switching elements 29a are arranged on the first intake port 103a side. In a side view from the first intake port 103a, the DC-DC converter faces the first intake port 103a. This configuration is highly effective to cool the switching elements 29a of the DC-DC converter.

Furthermore, in the unit cooler 1, the inverter 19a faces the first intake port 103a in the side view, which is highly effective to cool the inverter 19a.

Accordingly, the unit cooler 1 includes the air conditioning unit 200 that has the DC-DC converter, and has excellent cooling performance. As a result, the unit cooler 1 is capable of achieving high versatility and practicality.

FIG. 8 is a cross-sectional view, illustrating a main part of a unit cooler according to a second embodiment. This unit cooler includes a bracket 11g. The bracket 11g includes fins 47b, 47c each having a plurality of projections and recesses 47f formed thereon. Other configurations are the same as those in the first embodiment.

In the unit cooler of the second embodiment, the plurality of projections and recesses 47f increases the heat releasing area, which allows the electric compressor 19 and the control device 29 to release heat more easily. Other effects are the same as those in the first embodiment.

Although the present disclosure has been described in accordance with the first and second embodiments above, it is not limited to the above-described first and second embodiment, and may be modified within the scope of the disclosure as appropriate.

For example, the unit cooler of the present disclosure may be used in various types of electric forklift trucks such as counter type, picking type, 3-way type, and refrigerator-freezer type electric forklift trucks, and may be used in a wide range of industrial vehicles such as various types of engine forklift trucks, a transport equipment, and a towing vehicle.

This specification also includes the following disclosures.

Additional note 1
A unit cooler comprising:
a housing having an intake port through which air is drawn in, and a discharge port through which the air drawn in through the intake port is discharged;
an air conditioning unit accommodated in the housing, forming a refrigeration cycle, and configured to cool the air drawn in through the intake port and discharge the cooled air through the discharge port;
a base frame made of a metal plate disposed in the housing, and on which the air conditioning unit is mounted,
the air conditioning unit including an electric compressor, a condenser, a pressure reducing device, an evaporator, a first fan configured to rotate to blow the air to flow through the condenser, a second fan configured to rotate to blow the air to flow through the evaporator, an inverter configured to drive the electric compressor, and a power conversion device configured to convert electric power to be input to the inverter, wherein
the base frame includes a bracket to which the electric compressor is fixed, the bracket being formed by bending such that the air drawn in through the intake port with rotation of the first fan flows to the power conversion device.

Additional note 2
The unit cooler according to Additional note 1, wherein
the electric compressor is attached to an upper surface of the bracket, and
the power conversion device is attached to a lower surface of the bracket.

Additional note 3
The unit cooler according to Additional note 1 or 2, wherein
   the bracket has a seating surface to which a mounting leg of the electric compressor is mounted, and a fin that is formed by bending and has a stepped shape, and
   the fin extends away from the intake port.

Additional note 4
The unit cooler according to any one of Additional notes 1 to 3, wherein
the bracket has a through hole that is opened so that the air flowing toward the power conversion device flows toward the first fan.

Additional note 5
The unit cooler according to any one of Additional notes 1 to 4, wherein
the power conversion device includes a plurality of switching elements,
the switching elements are arranged on the intake port side, and
the power conversion device faces the intake port in a side view from the intake port side.

Additional note 6
The unit cooler according to any one of Additional notes 1 to 5, wherein
the inverter faces the intake port in the side view.

### INDUSTRIAL APPLICABILITY

The present disclosure can be used for a unit air conditioner that can be installed as an option in an industrial vehicle.

What is claimed is:

1. A unit cooler comprising:
a housing having an intake port through which air is drawn in, and a discharge port through which the air drawn in through the intake port is discharged;
an air conditioning unit accommodated in the housing, forming a refrigeration cycle, and configured to cool the air drawn in through the intake port and discharge the cooled air through the discharge port; and
a base frame made of a metal plate disposed in the housing, and on which the air conditioning unit is mounted,
the air conditioning unit including an electric compressor, a condenser, a pressure reducing device, an evaporator, a first fan configured to rotate to blow the air to flow through the condenser, a second fan configured to rotate to blow the air to flow through the evaporator, an inverter configured to drive the electric compressor, and a power conversion device configured to convert electric power to be input to the inverter, wherein
the base frame includes a bracket to which the electric compressor is fixed, the bracket being formed by bending such that the air drawn in through the intake port with rotation of the first fan flows toward the power conversion device.

2. The unit cooler according to claim 1, wherein
the electric compressor is attached to an upper surface of the bracket, and
the power conversion device is attached to a lower surface of the bracket.

3. The unit cooler according to claim 2, wherein
the bracket has a seating surface to which a mounting leg of the electric compressor is mounted, and a fin that is formed by bending and has a stepped shape, and
the fin extends away from the intake port.

4. The unit cooler according to claim 1, wherein
the bracket has a through hole that is opened so that the air flowing toward the power conversion device flows toward the first fan.

5. The unit cooler according to claim 1, wherein
the power conversion device includes a plurality of switching elements,
the switching elements are arranged on the intake port side, and
the power conversion device faces the intake port in a side view from the intake port side.

6. The unit cooler according to claim 5, wherein
the inverter faces the intake port in the side view.
